(19) United States
(12) Patent Application Publication
(10) Pub. No.: US 2016/0111090 A1
(43) Pub. Date: Apr. 21, 2016

(54) HYBRIDIZED AUTOMATIC SPEECH RECOGNITION

(71) Applicant: General Motors LLC, Detroit, MI (US)

(72) Inventors: John L. Holdren, Ferndale, MI (US); Gaurav Talwar, Novi, MI (US); Xufang Zhao, Windsor (CA); Matthew J. Heger, Waterford, MI (US)

(21) Appl. No.: 14/515,933

(22) Filed: Oct. 16, 2014

(51) Int. Cl. G10L 15/28; G10L 15/22

(52) U.S. Cl. CPC G10L 15/28; G10L 15/22

(57) ABSTRACT

A system and method of providing speech received in a vehicle to an automatic speech recognition (ASR) system includes: receiving speech at the vehicle from a vehicle occupant; providing the received speech to a remotely-located ASR system and a vehicle-based ASR system; and thereafter determining a confidence level for the speech processed by the vehicle-based ASR system; presenting in the vehicle results from the vehicle-based ASR system when the determined confidence level is above a predetermined confidence threshold is not above; presenting in the vehicle results from the remotely-located ASR system when the determined confidence level is not above a predetermined confidence threshold.

### TECHNICAL FIELD

The present invention relates to speech recognition and, more particularly, to speech recognition performed locally as well as at a remote location.

### BACKGROUND

Vehicle occupants use automatic speech recognition (ASR) systems to verbally communicate a variety of commands or messages while operating a vehicle. As a vehicle occupant speaks, a microphone located at the vehicle can receive that speech, convert the speech to electrical signals, and pass the signals to an ASR system that uses them to determine the content of the received speech. ASR systems can be located at a vehicle where speech recognition can be carried out locally using grammars stored on-board the vehicle. However, it is also possible to wirelessly transmit received speech to a remotely-located ASR system where a number of grammars can be used to determine the content of the speech.

Performing speech recognition at ASR systems located either on the vehicle or at the remote location can result in some tradeoffs. For instance, speech received at the vehicle and processed using the vehicle ASR system can begin speech recognition sooner than if the received speech is sent outside of the vehicle. But the grammars stored at the vehicle and used by the vehicle ASR system may be limited in their content, or the processing power of the vehicle ASR system may be limited when compared with a remotely-located ASR system. In contrast, wirelessly transmitting the received speech to the remotely-located ASR system can suffer from a transmission delay related to the wireless transmission of received speech and the wireless reception of speech analysis results related to the received speech. Selectively communicating speech received in the vehicle to the vehicle ASR system, the remotely-located ASR system, or both can increase response times when a vehicle can access ASR systems at either location.

### SUMMARY

According to an embodiment, a method includes providing speech received in a vehicle to an automatic speech recognition (ASR) system. The method includes receiving speech at the vehicle from a vehicle occupant; providing the received speech to a remotely-located ASR system and a vehicle-based ASR system; and thereafter determining a confidence level for the speech processed by the vehicle-based ASR system; presenting in the vehicle results from the vehicle-based ASR system when the determined confidence level is above a predetermined confidence threshold is not above; presenting in the vehicle results from the remotely-located ASR system when the determined confidence level is not above a predetermined confidence threshold.

According to another embodiment, a method includes providing speech received in a vehicle to an automatic speech recognition (ASR) system. The method includes receiving speech at the vehicle from a vehicle occupant; applying a context classifier to the received speech before continuing with speech recognition processing; determining from output of the context classifier that the received speech is associated with vehicle-based speech processing; and sending the received speech to the vehicle-based ASR system rather than a remotely-located ASR system based on step (c).

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a block diagram depicting an embodiment of an automatic speech recognition (ASR) system;

FIG. 3 is a flow diagram depicting an embodiment of a method of providing speech received in the vehicle to an ASR system; and

FIG. 4 is a flow diagram depicting another embodiment of a method of providing speech received in the vehicle to an ASR system.

### DETAILED DESCRIPTION OF THE ILLUSTRATED EMBODIMENT(S)

The system and method described below improves the speed at which speech recognition results are returned to a vehicle occupant by selectively providing speech received at the vehicle to an automatic speech recognition (ASR) system located at the vehicle, an ASR system located remote from the vehicle, or both. In one implementation, speech received at the vehicle from a vehicle occupant can be simultaneously provided to both the ASR system at the vehicle and the remote ASR system. The ASR system at the vehicle can begin processing the received speech at the same time the received speech is also being sent to the remotely-located ASR system.

In the past, received speech has been processed by providing it to the ASR system located at the vehicle and then waiting for a speech recognition output. If the output from the vehicle ASR system was not satisfactory, the vehicle would then transmit the received speech to the remote ASR system. By alternately providing received speech to the vehicle-based ASR system and then later to remote-based ASR systems, speech recognition results can be obtained at a reduced cost due to a decreased consumption of wireless communications from the vehicle. However, when the vehicle ASR system is unable to satisfactorily analyze the received speech the vehicle occupant has likely already experienced a delay between uttering the speech and the time the vehicle ASR system determines that it could not identify the received speech.

Providing received speech simultaneously to both the vehicle ASR system and the remotely-located ASR system results in quicker speech recognition results when the vehicle ASR system generates speech recognition results that fall below a predetermined acceptable probabilistic or confidence threshold. In that case, the remote ASR system has already been initiated to generate speech recognition results for the received speech when the vehicle ASR system results are unacceptable. Thus, the speech recognition results generated by the remotely-located ASR system can be significantly further along than if the vehicle waited to initiate such processing until after determining that speech recognition at the vehicle was unacceptable. By transmitting received speech to the remotely-located ASR system at the same time the speech is provided to the vehicle ASR system, remote speech recognition results may have already been generated and received at the vehicle at the same time or shortly after the vehicle determines its speech recognition results are not acceptable.

Speech recognition processing can also be improved by analyzing the context of received speech and using the context to determine whether to perform speech recognition using the vehicle ASR system or to send the received speech to the remotely-located ASR system. The vehicle can use a pre-processing portion of the vehicle ASR system to identify keywords and/or statistically analyze the received speech to identify the context of received speech. Based on the determined context, the vehicle can determine that the received speech would be more-efficiently processed at the vehicle or that the received speech should be wirelessly transmitted to the remotely-located ASR.

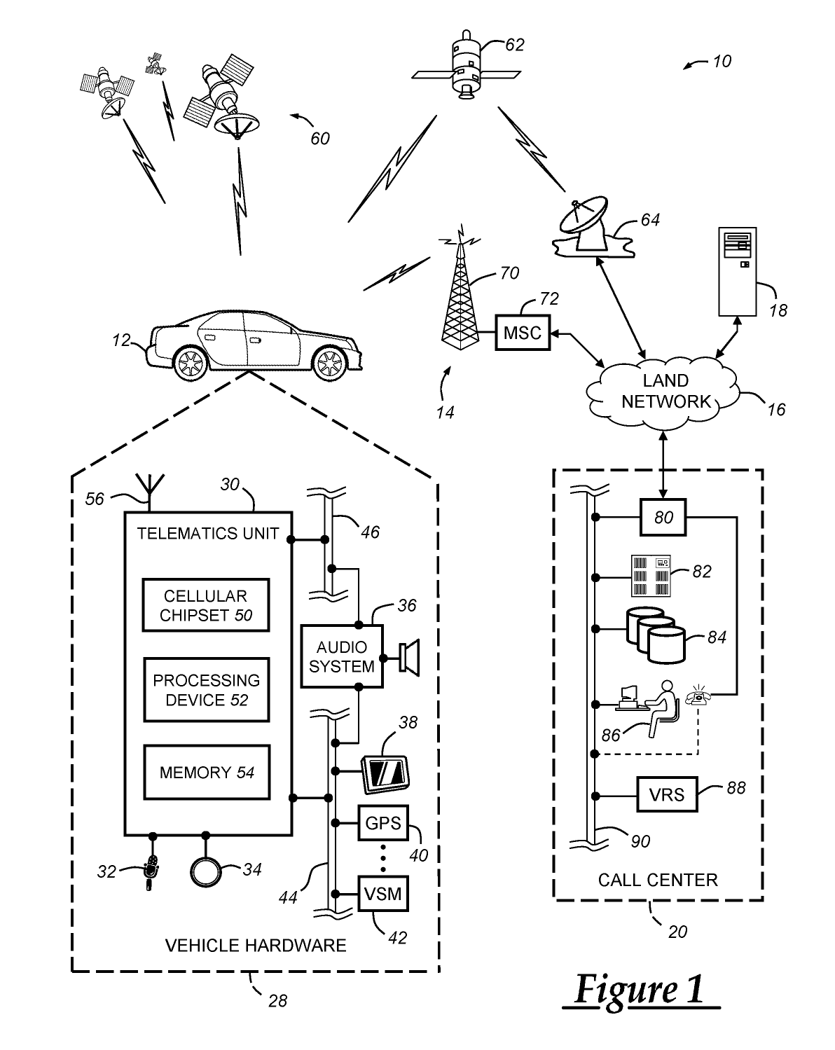

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. The computer 18 is shown as operating a remotely-located automatic speech recognition (ASR) system 74. The components and function of the remotely-located ASR system 74 will be discussed in more detail below. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

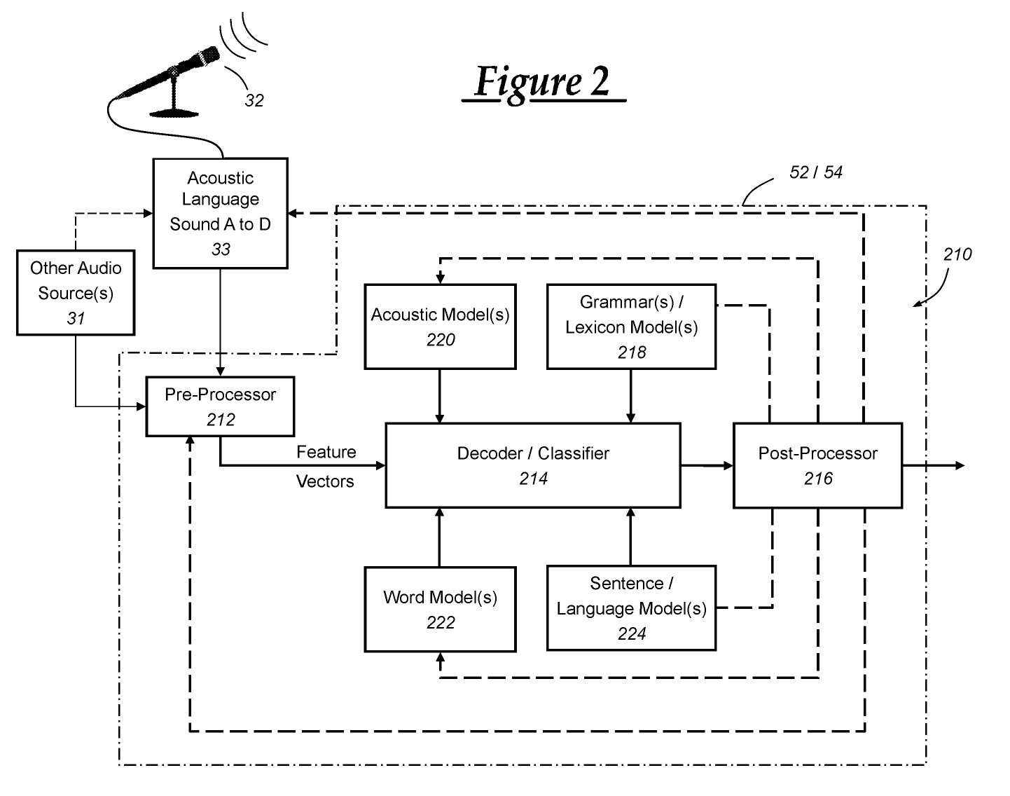

Turning now to FIG. 2, there is shown an illustrative architecture for an automatic speech recognition (ASR) system 210 that can be used to enable the presently disclosed method. In general, a vehicle occupant vocally interacts with an ASR system for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like.

The ASR system 210 is shown in the vehicle 12. However, the elements included in the ASR system 210 and concepts discussed with respect to the ASR system 210 may also be found in the remotely-located ASR system 74 located at the computer 18, with some differences. For example, the remotely-located ASR system 74 can include more sophisticated processing capabilities and language models as well as more up-to-date language models when compared with ASR system 210. When using the remotely-located ASR system 74, the vehicle 12 can packetize speech received via the microphone 32 at the vehicle 12 and wirelessly transmit the speech to the remotely-located ASR system 74 over the wireless carrier system 14. After outputting a result, the remotely-located ASR system 74 can packetize speech recognition results and wirelessly transmit them to the vehicle 12. While the remotely-located ASR system 74 is shown in the computer 18, it is also possible to locate the system 74 elsewhere, such as in the server 82 and database 84 of the call center 20. In one example of how a remotely-located ASR system is carried out, Google™ provides an application programming interface (API) that can be used with its Android™ software used by Droid™ wireless mobile devices. As shown in regard to the communication system 10, the remotely-located ASR system 74 can be implemented at the computer 18, the servers 82/databases 84 of the call center 20, or another computer-based server facility located remote from the vehicle 12.

Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific illustrative ASR system 210. The system 210 includes a device to receive speech such as the telematics microphone 32, and an acoustic interface 33 such as a sound card of the telematics unit 30 having an analog to digital converter to digitize the speech into acoustic data. The system 210 also includes a memory such as the telematics memory 54 for storing the acoustic data and storing speech recognition software and databases, and a processor such as the telematics processor 52 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances; and one or more post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind

One or more modules or models can be used as input to the decoder module(s) 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 ms duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

The pre-processing module(s) 212 can also store a context classifier that can be implemented by a rule-based classifier or a statistically-based classifier. The context classifier can be applied to the recognized text from the received speech of the vehicle occupant and used to identify the conversational context of that speech. Generally speaking, the context classifier is not directed to understanding precise content of the received speech but rather the speech context. For example, the rule-based classifier can access a plurality of stored contexts that are each associated with a list of words. These contexts and their associated words can be stored in the grammar modules 218 or any other memory location accessible by the ASR 210. When using a rule-based classifier, the ASR system 210 can identify one or more words in the received speech that match one or more words associated with a context. When the ASR system 210 detects a matching word, the ASR system 210 can determine the associated context with that word. For example, the rule-based classifier can parse the received speech and identify the presence of words “address” and “directions” in the speech. The ASR system 210 can use the rule-based classifier to determine if the identified words are associated with a context. In this example, the words “address” and “directions” could be associated with a vehicle navigation context. The presence of these detected words can then cause the rule-based classifier to assign the “navigation” context to the received speech. In a different example, the ASR system 210 can detect the words “email” or “text” and determine that those words are associated with a dictation context.

The statistically-based classifier may identify individual words or combinations of words in received speech and then identify a statistical likelihood that the extracted word(s) are associated with a particular context. Statistically-based classifiers can be implemented in a variety of ways. In one example, the statistically-based classifier can analyze the recognized text and classify it into a predefined set of contexts that indicate potential user intents such as a navigation route request, a point of interest, a phone call, or an email dictation context. The statistically-based classifier can annotate recognized text by using pattern classification techniques such as support vector machines, information theory, entropy measure-based methods, or neural networks, and assign corresponding confidence value using these techniques. Statistically-based classifiers can include Baysian classifiers, N-gram models, and recursive training models, to name a few. Statistically-based classifiers may be trained over a period of time to listen for particular words or combinations of words in received speech and then, after some action is carried out after the received speech, learn the context of that action. The training of statistically-based classifiers can then be used to predict the context of speech received in the future. In one example, the statistically-based classifier can analyze words included in received speech and then learn that the GPS module 40 of the vehicle 12 had been used as a result of analyzing the words. The statistically-based classifier could then associate a “navigation” context with the analyzed acoustical parameters. As the statistically-based classifier gathers words or strings of words and contexts associated with them, the statistically-based classifier can compare them with words extracted in the future to determine a likely context. So, when the statistically-based classifier extracts words from received speech and compares them to previously-extracted words or strings of words and their associated context, the statistically-based classifier can identify similarities between present and past parameters. When a similarity exists, the statistically-based classifier can infer that the context associated with past words or combinations of words is statistically likely to apply to the present words.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

The method or parts thereof can be implemented in a computer program product embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

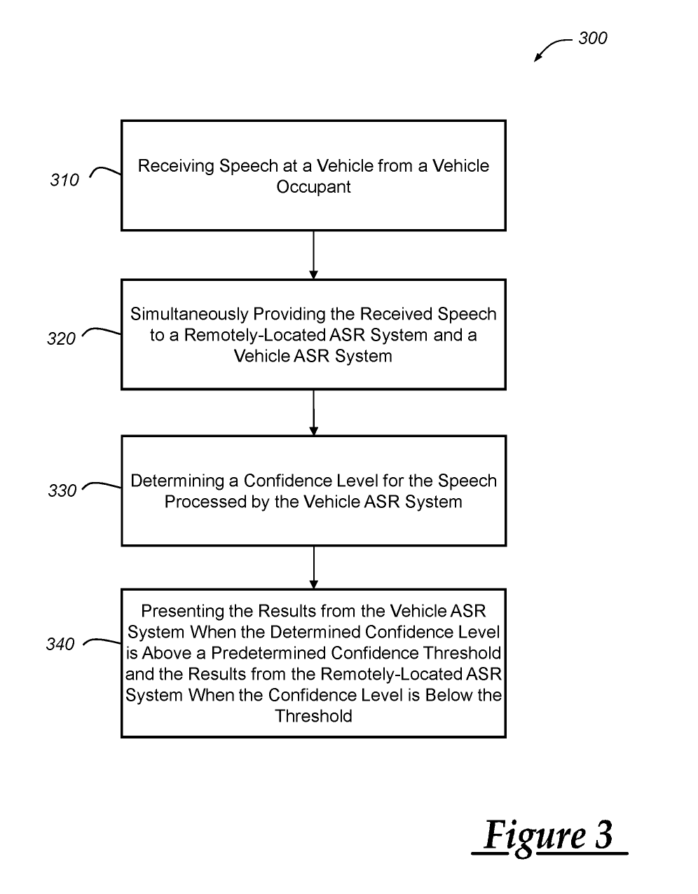

Turning now to FIG. 3, there is shown a method 300 of providing speech received in the vehicle 12 to an ASR system. The method 300 begins at step 310 by receiving speech at the vehicle 12 from a vehicle occupant. A person located in the vehicle 12 can interact with the ASR system 210 discussed above by speaking into the microphone 32 of the vehicle 12. The microphone 32 is communicatively linked to the processing device 52, which can begin performing speech recognition analysis on the received speech using the ASR system 210. The speech provided by the vehicle occupant to the ASR system 210 can relate to a large number of contexts and include a wide range of vocabulary. In one sense, vehicle occupants are likely to utter speech related to vehicle functions, which can be readily understood by an ASR system at a vehicle. Vehicle ASR systems can be trained to recognize words or commands such as “directions” and “point of interest” that commonly arise as part of vehicle travels. However, vehicle occupants can also request speech recognition for speech relating to non-vehicle contexts. For example, vehicle occupants may rely on ASR systems to dictate email messages. The content of an email message can be directed to any one (or more) of many contexts. The method 300 proceeds to step 320.

At step 320, the received speech is simultaneously provided to the remotely-located ASR system 74 and the ASR system 210. At the same time the processing device 52 begins to process the received speech, the vehicle telematics unit 30 can wirelessly send the entire contents of the received speech from the vehicle 12 to the remotely-located ASR system 74, regardless of speech content. As the ASR system 210 is identifying the content of the received speech, it is also being wirelessly transmitted from the vehicle telematics unit 30 over the wireless carrier system 14 and land network 16 to the computer 18 where the remotely-locate ASR system 74 is located. The method 300 proceeds to step 330.

At step 330, a confidence level is determined for the speech processed by the vehicle-based ASR system 210. The ASR system 210 can output an N-best list of vocabulary results as recognized speech and assign a confidence value, in the form of a percentage, to each vocabulary result. In one example, the ASR system 210 can analyze the received speech and output three vocabulary results representing possible interpretations of the speech and have confidence values of 42%, 45%, and 47%. The confidence values can represent a level of confidence that the ASR system 210 has correctly interpreted the received speech. The method 300 proceeds to step 340.

At step 340, the results from the vehicle-based ASR system 210 are presented in the vehicle 12 when the determined confidence level is above a predetermined confidence threshold. As part of producing the confidence value for each vocabulary result, the ASR system 210 can compare those values to a predetermined confidence threshold. For instance, the predetermined confidence threshold could be set at 40%. Results having confidence values above this value can be presented to the vehicle occupant. Using the example values above, the ASR system 210 can output the possible interpretations of the speech in order of their confidence values of 47%, 45%, and 42% from highest to lowest.

However, the ASR system 210 may determine that the determined confidence level(s) of the speech recognition results from the vehicle-based ASR system 210 are below the predetermined confidence threshold. In that case, the processing device 52 may determine if it has received speech recognition results from the remotely-located ASR system 74. If not, the processing device 52 may choose to wait a predetermined amount of time for the speech recognition results after which time the processing device 52 can play a prompt that the received speech is unable to be understood. On the other hand, if the processing device 52 determines that the speech recognition results from the remotely-located ASR system 74 have already arrived or have arrived before the predetermined amount of time expires, then the processing device 52 can determine if the results are acceptable. For example, the processing device 52 can compare the results from the remotely-located ASR system 74 with the predetermined confidence threshold. If the results from the remotely-located ASR system 74 are above the predetermined confidence threshold, the processing device 52 can audibly play them to the vehicle occupant via the audio system 36. Otherwise, the processing device 52 could reject both the results from ASR system 210 and remotely-located ASR system 74 if results from both fall below the predetermined threshold. In one implementation, the results from both the ASR system 210 and remotely-located ASR system 74 lie somewhat above the predetermined threshold, such as no more than twenty percent above, the processing device 52 can present the results from both the ASR system 210 and remotely-located ASR system 74.

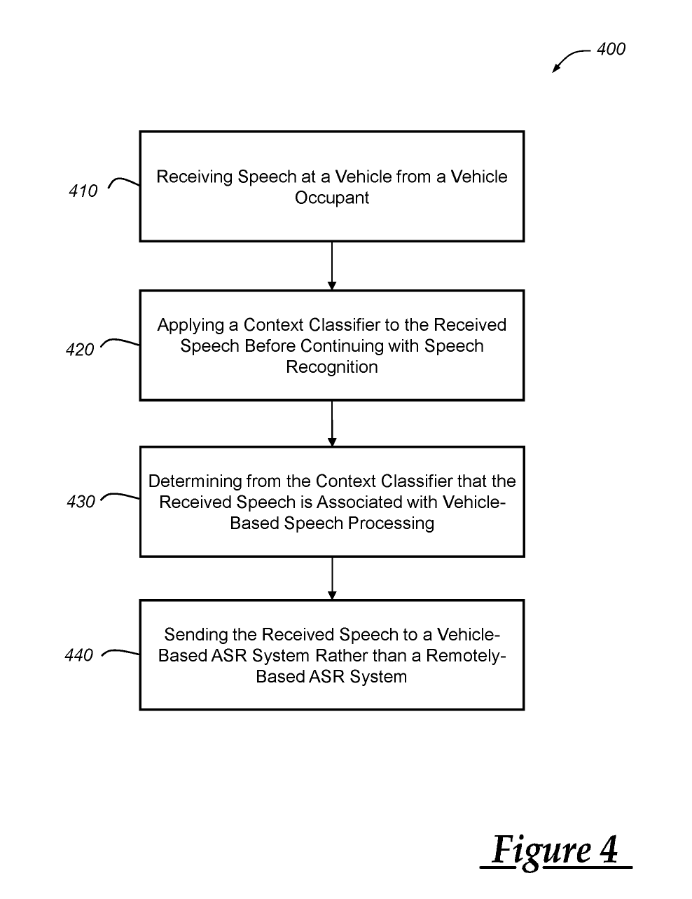

Turning to FIG. 4, there is shown a method 400 of providing speech received in the vehicle 12 to an ASR system. The method 400 begins at step 410 by receiving speech at the vehicle 12 from a vehicle occupant. This step can be accomplished as described above with respect to FIG. 3 and step 310. The method 400 proceeds to step 420.

At step 420, a context classifier is applied to the received speech before continuing with speech recognition processing. The ASR system 210 at the vehicle 12 can use its pre-processing module 212 to identify the context of the received speech. The context classifier can be implemented in different ways, such as by using a rule-based classifier or a statistically-based classifier. As discussed above, the context classifier can identify keywords included in the received speech that indicates an identifiable context for the speech. Or in another example, the context classifier can act upon the recognized text and classify it into a predefined set of user intents referred to here as context categories. To perform statistical classification, a number of techniques can be used, such as Support Vector Machines, neural networks, and n-gram models, to name a few. Context generally relates to a task performed by the vehicle occupant. As discussed above, examples of context can include “navigation” that involves providing turn-by-turn directions to the vehicle occupant using, at least in part, the GPS module 40. “Dictation” can be a context when the vehicle occupant sends email or SMS messages by interacting with speech recognition services and a messaging client. Once a context is associated with the received speech, the method 400 proceeds to step 430.

At step 430, it is determined from output of the context classifier that the received speech is associated with vehicle-based speech processing. Some contexts can be processed more efficiently at the ASR system 210 located at the vehicle 12 when compared to processing speech associated with that context remotely. Using the examples above, the ASR system 210 may have grammars and acoustical models that are tuned to respond to communications in the “navigation” context as well as other in-vehicle conversations. Apart from “navigation,” other vehicle-related contexts are possible, such as “vehicle diagnosis,” “traffic,” or “point of interest.” The method 400 proceeds to step 440.

At step 440, the received speech is sent to the vehicle-based ASR system rather than a remotely-located ASR system based on determining that the context of received speech is vehicle-related. When a vehicle-related context is identified from context classifier, the processing device 52 at the vehicle 12 can determine that the ASR system 210 at the vehicle 12 is optimized to process the speech as discussed above. However, when the ASR system 210 at the vehicle 12 determines that the context of the received speech is non-vehicle related, the ASR system 210 can direct the vehicle telematics unit 30 to wirelessly transmit the speech to the remotely-located ASR system 74 for remote speech processing. This can occur when the vehicle occupant is dictating email messages. The vehicle telematics unit 30 can then receive the results from the remote speech processing at the vehicle 12 and present the results to the vehicle occupant via the audio system 36. The method 400 then ends. In such a method, where it may be determined from the output of the context classifier that the received speech is not associated with vehicle-based ASR, the method can instead send the speech to the remotely-located ASR system, or can send it to both the vehicle and the remotely-located ASR systems, as discussed in connection with FIG. 3.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing speech received in a vehicle to an automatic speech recognition (ASR) system, comprising the steps of:
(a) receiving speech at the vehicle from a vehicle occupant;
(b) providing all of the received speech to a remotely-located ASR system and all of the received speech to a vehicle-based ASR system; and thereafter
(c) determining a confidence level for the speech processed by the vehicle-based ASR system;
(d) presenting in the vehicle results from the vehicle-based ASR system when the determined confidence level is above a predetermined confidence threshold;
(e) presenting in the vehicle results from the remotely-located ASR system when the determined confidence level is not above a predetermined confidence threshold.

2. The method of claim 1, further comprising the steps of: comparing the determined confidence level for the speech processed by the vehicle-based ASR system with a confidence level of the remotely-located ASR system and, if both confidence levels are within a predetermined range from the predetermined confidence threshold, presenting the results from both the vehicle-based ASR system and the remotely-located ASR system.

3. The method of claim 1, further comprising the step of determining a context of the received speech at the vehicle-based ASR system.

4. The method of claim 3, further comprising the step of storing a context classifier at the vehicle-based ASR system.

5. The method of claim 4, wherein the context classifier further comprises a rule-based classifier.

6. The method of claim 4, wherein the context classifier further comprised a statistically-based classifier.

7. The method of claim 1, further comprising the step of presenting a plurality of results from the vehicle-based ASR system in the vehicle.

8. The method of claim 1, further comprising the step of determining that the speech recognition results from the remotely-located ASR system have arrived before a predetermined amount of time expires.

9. The method of claim 8, further comprising the step of permitting speech recognition results to be presented in the vehicle in response to the arrival of speech recognition results from the remotely-located ASR system before the predetermined amount of time expires.

10. The method of claim 1, further comprising the step of simultaneously providing the received speech to the remotely-based ASR system and the vehicle-based ASR system.

11. A method of providing speech received in a vehicle to an automatic speech recognition (ASR) system, comprising the steps of:
(a) receiving speech at the vehicle from a vehicle occupant;
(b) applying a context classifier to the received speech before continuing with speech recognition processing;
(c) determining from output of the context classifier that the received speech is associated with vehicle-based speech processing based on the identification of a vehicle-related context; and
(d) sending all of the received speech to the vehicle-based ASR system rather than a remotely-located ASR system based on step (c).

12. The method of claim 11, further comprising the step of storing the context classifier at the vehicle-based ASR system.

13. The method of claim 12, wherein the context classifier further comprises a rule-based classifier.

14. The method of claim 12, wherein the context classifier further comprised a statistically-based classifier.

15. The method of claim 12, further comprising the step of presenting a plurality of results from the vehicle-based ASR system in the vehicle.

16. The method of claim 11, further comprising the step of receiving speech recognition results from the remotely-located ASR system and presenting them in the vehicle via an audio system.
